(19) United States
(12) Patent Application Publication
(10) Pub. No.: US 2016/0048721 A1
(43) Pub. Date: Feb. 18, 2016

(54) SYSTEM AND METHOD FOR ACCURATELY ANALYZING SENSED DATA

(71) Applicant: Joseph Cole Harper, Chicago, IL (US)

(72) Inventor: Joseph Cole Harper, Chicago, IL (US)

(21) Appl. No.: 14/823,569

(22) Filed: Aug. 11, 2015

Related U.S. Application Data
(60) Provisional application No. 62/036,207, filed on Aug. 12, 2014.

(51) Int. Cl. G06K 9/00; H04N 7/18; H04N 5/232; G06T 7/20

(52) U.S. Cl. CPC G06K 9/00221; G06T 7/2033; G06K 9/00771; G06K 9/00778; H04N 7/181; H04N 5/23206; G06T 2207/10016

(57) ABSTRACT

A system for analyzing sensed data. A triggering mechanism is responsive to the presence of a target. A sensor acquires sensed data of the target, for example, an image. A processor analyzes the sensed data to detect the target. The signals generated by the triggering mechanism and the sensor are reconciled. In the reconciliation of the signals, when a pair of signals each indicate the presence of the target within a predefined time period, a target data set corresponding to the pair of signals is generated. When the presence of the target is indicated by only one of the triggering mechanism and sensor, the detection of target or the failure to detect the target is more reliable is reconciled. If the signal indicating detection of the target is determined to be more reliable, a target data set is generated. A method for analyzing sensed data is also disclosed.

### CROSS REFERENCE TO RELATED APPLICATIONS

This application claims priority under 35 U.S.C. 119(e) of U.S. provisional patent application Ser. No. 62/036,207 filed on Aug. 12, 2014 entitled METHOD OF ACCURATELY ANALYZING IMAGES the disclosure of which is hereby incorporated herein by reference.

### BACKGROUND

The present invention relates to the field of analyzing sensor data including image analysis.

While many systems and methods for analyzing sensor data and images have been developed, conventional systems are not foolproof and may incorrectly identify or entirely miss the target of interest.

Improvements to systems and methods for analyzing sensor data and images which improve the accuracy of such systems and methods remain desirable.

### SUMMARY

The present invention provides a system and method which utilizes a trigger mechanism and a sensor to provide sensor data analysis with enhanced accuracy through a reconciliation or intelligence process.

The invention comprises, in one form thereof, a system for analyzing sensed data to acquire information about at least one target in at least one predefined spatial zone. The system includes a triggering mechanism configured to communicate to the system a first signal responsive to the presence of a target in a first predefined spatial zone. A sensor is configured to acquire sensed data of the target in a second predefined spatial zone and communicate to the system a second signal including the sensed data. At least one processor in communication with the system is configured to analyze the sensed data and determine if the sensed data detects the target. The at least one processor is further configured to reconcile the first and second signals respectively generated by the triggering mechanism and the sensor. The reconciling of the first and second signals involves implementing logic wherein: when a pair of first and second signals each respectively indicate the presence of the target in the first and second predefined spatial zones within a predefined time period, the at least one processor generates a target data set corresponding to the pair of first and second signals; and when the presence of the target in one of the first and second predefined spatial zones is indicated by only one of the first and second signals, the at least one processor is configured to determine whether the detection of the target is more reliable than the absence of detection, and, if the detection of the target is determined to be more reliable, the at least one processor generates a target data set corresponding to the one signal indicating detection of the target.

In some embodiments of the system, when the presence of the target in one of the first and second predefined spatial zones is indicated by only one of the first and second signals, the at least one processor saves a target data set corresponding to the one signal indicating detection of the target only if the detection of the target is determined to be more reliable than the absence of detection. In other embodiments, when the presence of the target in one of the first and second predefined spatial zones is indicated by only one of the first and second signals, the at least one processor generates a target data set corresponding to the one signal indicating detection of the target and flags the target data set. Flagging the data set can be used to indicate that it is less trustworthy and/or enable it to be reviewed by an administrator who can then save, modify or delete the flagged data set.

The sensor may take various forms, for example, a weight sensor, a motion detector or image sensor. The preferred embodiment of the sensor is an image sensor that is configured to acquire an image of the target in the second predefined spatial zone and the at least one processor is configured to analyze the image to detect the target in the image. When employing a system having an image sensor, when a target data set is generated and the corresponding second signal includes an acquired image, the target data set advantageously includes the acquired image.

In some embodiments employing an image sensor, the image sensor acquires an image responsive to the generation of the first signal by the triggering mechanism. In other embodiments, the image sensor acquires images independently of the operation of the triggering mechanism.

In other embodiments of the system, each of the first and second signals includes a time stamp and the at least one processor compares the time stamps of the first and second signals to determine if a pair of first and second signals are within a predefined time period. In some embodiments, the first and second predefined spatial zones are the same spatial zone while in others, the first and second predefined zones are different spatial zones.

Various different approaches may be employed to determine which signal is more reliable. For example, in some embodiments, the communication or absence of the first signal is always determined to be more reliable than the communication or absence of the second signal. In other embodiments, the at least one processor is configured to receive user input when determining whether the communication of one signal is more reliable than the absence of the other signal.

It will generally be advantageous if each of the target data sets includes a target count, however, this is not essential. The target of the system may be a wide variety of different items. For example, in many systems the target will be a human. For some applications, however, the target may be a vehicle, non-human animal, an object, a manufactured product, a combination of different types of targets, or a plurality of any of the aforementioned targets.

When the target is a human, each of the target data sets may include additional information about the specific target that was identified such as a value for the target gender, the target age, the target ethnicity and/or the target mood. The target data set may be expanded to include or compared with information gathered from an external system. The target data set might also be analyzed by or integrated with an external system. Similarly, data gathered from a triggering mechanism or sensor in the system may be used to expand, compare and analyze the target data set.

Various forms of triggering mechanism may be used with the system. For example, the triggering mechanism may be a motion detector, an automated door opener, counting device, another sensor, a beacon, a scanner, an interaction with an intelligent device or machine, interaction with a machine or device, such as a button or screen being pressed, a machine or software implemented method, an RFID card reader or other suitable mechanism or method of detection.

The at least one processor may also be configured to receive user input allowing for the selective correction, verification, or deletion of data values in the target data sets and selective interaction with and deletion of the target data sets.

The processor may also be configured to automatically interact with other systems, such as triggering a notification, activating a security setting or interacting with a third party application.

The system can be employed in various contexts. For example, the system can be used to monitors entry of targets into a predefined space having limited entry and exit portals. A more specific example of such a system would involve a situation where entry into the space requires a ticket and the triggering mechanism is a ticket reader such as at a sporting or cultural event. Another more specific example of such a system might include a triggering mechanism that is an automated entry device such as at the entry to a garage or a floor mat sensor that actuates a door for a grocery store. In other more specific examples, the triggering mechanism might be a security system, such as those employed at secure facilities requiring RFID badges to enter controlled spaces at the facility. Such systems may not only monitor targets entering the predefined space but also monitor targets exiting the predefined space through an exit portal.

In yet other embodiments of the system, the system monitors a client service structure. Examples of such client service structures include automated teller machines and self-service point-of-sale devices.

Another specific example of an embodiment of the system involves the triggering mechanism and the sensor being installed in a vehicle with the target being an occupant of the vehicle and the sensor being adapted to acquire an image of the target.

In another example of an embodiment of the system, the first and second predefined zones may be portions of a roadway wherein the target is a vehicle and the sensor is adapted to acquire an image of the target. In such an embodiment, the target data sets may include a value for the number of passengers in the vehicle. Such an application could be advantageously employed to monitor high occupancy or carpool lanes which are only open to vehicles having a minimal number of occupants, e.g., at least 2 occupants.

In some embodiments of the system, the at least one processor may also be configured to filter target data sets to identify a subset of one or more targets.

While many embodiments of the system will be used to monitor areas of interest in and adjacent the built environment, nearly any area of interest can be monitored with a system as described herein. For example, such systems can be used to monitor an area of interest remote from the built environment such a location in a park. In might also be used in even more remote locations such as in the wilderness, e.g., in the middle of a forest, to monitor wildlife.

The invention comprises, in another form thereof, a method of analyzing images to acquire information about at least one target in at least one predefined spatial zone. The method includes generating a signal responsive to the presence of a target in a first predefined spatial zone using a triggering mechanism; acquiring an image of the target in a second predefined spatial zone with an imaging sensor and generating a second signal including the image. The method also includes analyzing the image to detect the target in the image and reconciling the first and second signals by generating a target data set when a pair of first and second signals respectively indicate the presence of the target in the first and second predefined spatial zones within a predefined time period; and when the detection of the target in one of the first and second predefined spatial zones is indicated by only one of the first and second signals, determining whether the detection of the target is more reliable than the absence of detection, and, if the detection of the target is determined to be more reliable than the absence of detection, generating a target data set corresponding to the one signal indicating detection of the target.

In some embodiments of the method, when the detection of the target in one of the first and second predefined spatial zones is indicated by only one of the first and second signals, a target data set corresponding to the one signal indicating detection of the target is only saved if the detection of the target is determined to be more reliable than the absence of detection. In other embodiments of the method, when the detection of the target in one of the first and second predefined spatial zones is indicated by only one of the first and second signals, a target data set corresponding to the one signal indicating detection of the target is generated and subjected to further review. For example, the target data set might be flagged for administrator review with the administrator having the ability to review and then save, modify and/or delete the target data set.

In some embodiments, the method further includes the step of collecting the target data sets and generating a report communicating information based on the target data sets. In such a method involving the production of a report, the method may also include the step of filtering the target data sets to identify target data sets satisfying one or more predefined conditions and wherein the generated report includes information obtained by the filtering step.

In some embodiments of the method, the targets are humans entering a facility through an entrance. This embodiment may take various forms, for example, a plurality of paired triggering mechanisms and imaging sensors can be used to monitor separate locations at the facility. In such an embodiment involving the monitoring of separate locations, the method may further include the step of matching specific targets in the target data sets acquired from the separate locations at the facility to thereby track movement of the specific targets at the facility. This can be useful in a number of different situations. For example, the targets might be customers at a retail facility and the tracking of customer actions in the facility may lead to a more efficient and productive layout of the facility. Alternatively, the targets might be employees. The tracking of employees at a facility has a number of potentially beneficial uses. For example, it could be used to monitor the timeliness of employee arrivals and departures. It could also be used to monitor whether employees are abusing access to break areas such as a smoking area or break room. It might also be used to monitor employee work efforts. For example, it could be used to monitor the amount of time a sales person spends on the sales floor vs. time spent performing administrative tasks at a desk. It might also automatically indicate when an employee arrived and departed throughout the day, the frequency of breaks, and/or the length of breaks.

In some embodiments, the method further includes communicating a message to an external system responsive to the generation of a target data set. In some such methods, the method might also include filtering the target data sets and communicating the message to the external system only when the target data set satisfies one or more predefined conditions. For example, a system monitoring a secure facility could communicate a message to a security system that displays the message to a human operator when the number of individuals passing through a secured door exceeds the number of RFID cards read by a card reader located at the door. In still another example, where the system is monitoring vehicles on a roadway, the target data sets might include license plate information and the filtering process could involve filtering the data to identify a particular license plate and generating a message when that license plate was identified. The processor might also allow for output which is viewable, editable or linkable or which could be pushed, pulled, received, sent or shared with other systems.

Various other modifications to the systems and methods described above are also possible and encompassed within the scope of the present application.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a schematic view of a system for monitoring customers in a facility.

FIG. 2 is a schematic view of a system monitoring a human target.

FIG. 3 is a screen view showing a target data set and tools for managing such data sets.

FIG. 3A through FIG. 3G illustrate several examples of target data sets.

FIG. 4 is a view of a report based upon target data sets.

FIG. 5 is a view of another report based upon target data sets.

FIG. 6 is a view of another report based upon target data sets.

FIG. 7 is a view of another report based upon target data sets.

FIG. 8 is a view of another report based upon target data sets.

FIG. 9 is a view of another report based upon target data sets.

FIG. 10 is a view of another report based upon target data sets.

FIG. 11 is a view of another report based upon target data sets.

FIG. 12 is a view of another report based upon target data sets.

FIG. 13 illustrates an example of a triggering mechanism.

FIG. 14 illustrates an example of a triggering mechanism.

FIG. 15 illustrates an example of a triggering mechanism.

FIG. 16 illustrates an example of a triggering mechanism.

FIG. 17 illustrates an example of a triggering mechanism.

FIG. 18 illustrates an example of a triggering mechanism.

FIG. 19 schematically depicts the use of an exemplary system with an automated teller machine (“ATM”).

FIG. 20 schematically depicts the use of an exemplary system with a self-service point-of-sale device.

FIG. 21 schematically depicts the use of an exemplary system along a roadway.

FIG. 22 is a schematic depiction of a system installed in a vehicle.

FIG. 23 is a depiction providing further illustration of a system installed in a vehicle.

FIG. 24 is a depiction of a system installed at a location with defined entry and exit portals.

FIG. 25 is an image acquired outside a stadium.

FIG. 26 is an image acquired at an entry portal to a stadium.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The present invention may utilize image sensors such as still image cameras and video cameras, however, it may also be implemented with other forms of sensors which may be more appropriate for a given application such as microphones for recording audio, weight sensors, light sensors, and various other forms of sensors. Most commonly, however, it is thought that the sensor will be capable of acquiring an image.

Images are visual representations of things, usually of people, places, things, or other forms that can be visually analyzed. Oftentimes, the target of the sensors described herein will be people, however, some applications will be directed toward other targets. Various forms of image analysis techniques and software are currently available and known to those having ordinary skill in the art. Such image analysis may be performed for various purposes, including but not limited to forms of entertainment, recording, memorialization, or business intelligence. Many of the systems and methods described herein are useful for business intelligence, however, they may also be employed or modified for other purposes such as security and research.

Image analysis can be performed manually, automatically, procedurally, or a combination thereof. For example, technologies may attempt to automatically analyze and even “recognize” a person in an image through facial features and automatically identify attempt to identify that person in the form of a database, report, tag, or other means. This analysis is not always 100% accurate. Usually the outcome of the analysis is accurately identified, incorrectly identified (false positive), inconclusively identified (could not match to anything in the database), or not identified (no characteristics detected or the characteristics were not analyzed well enough for identification). When automated technologies fail, either another automated technology must identify the failure and start a new technology process, or a person must manually correct the analysis or perform the analysis.

Image analysis is not always as specific as identifying the individual's personal identity, as is the case with facial recognition. Sometimes the analysis is meant to identify features, including but not limited to the gender, age, ethnicity, attractiveness, hair color, clothing color, clothing, apparel, mood, height, weight, foot traffic pattern, behavior, action, or any other visually identifiable thing. One way of identifying a feature is by pre-assigning identifiers to other images in a database and then using that database to “closely match” to the image in question. This description will primarily use gender identification through “facial detection” as the preferred reference when describing the feature of analysis, but in no way are any descriptions herein limited to only gender as the sole feature of analysis, nor is “facial detection” the sole method in which to determine gender.

In the case of gender identification, imagine a database with two images—one of a male and one of a female. A new image is analyzed of a male subject and compared to the database. Ideally, that male more closely resembles the male in the database than the female in the database. However, the two database images may be insufficient for the technology to best determine, through automation, if the subject in question more closely resembles the male or the female in the database. It may correctly “match” the male subject to the male in the database, it may incorrectly “match” the male subject to the female in the database, it may be inconclusive (identified a subject, but could not find a match), or it may not have identified the subject in the image at all.

The inaccuracies can usually be minimized by comparing the image in question to a more robust database of images (less likely to be “inconclusive”, and more likely to find a look-a-like match). However, since the image itself is being visually analyzed, the technology is looking for a purely visual match, which may be insufficient. If the subject is a male that is visually feminine or a female that is visually masculine, it is possible for the technology to incorrectly identify the subject. Other inaccuracies can be attributed to the angle in which the image is captured, captured poorly, or not captured at all. For example, if the visual between the subject in question and the camera or similar device is at a sharp angle, too close, too far, or any deviation from ideal conditions, the image may not be correctly analyzed. Even if the camera is positioned perfectly, the subject may be looking down, to the side, backwards, or performing any other action or behavior that impedes the ability to properly analyze the image. Further, the subject may have features or apparel that make it difficult to analyze properly. If a subject is not identified at all, there would be no obvious way for the “facial detection” technology to know that it missed a subject or image to analyze at all. For at least these reasons, automation alone may be insufficient to correctly analyze an image.

The use of supplemental technology to improve the process of identifying subjects, or in the very least having at least one additional source of information to compare to, can help with the ultimate analysis of an image. For example, the use of video, rather than a still-image camera, would produce potentially thousands of images (frames) to be analyzed, which would allow for a greater chance of successful detection (identifying that a subject exists to be analyzed at all) and successful analysis. Another example would include the use of software that analyzes clothing style, labels, hair length, facial hair, and other features to help reconcile the facial features. Further, supplemental technology that detects a subject in an area of interest, such as the use of an overhead people counter, motion detector, or sensor, would allow the system to reconcile instances where a subject was picked up by one sensor but not another. Yet another example may include technologies that identify mobile devices, the use of other technologies (such as an ATM or vending machine), or some action that a subject may take to help identify their presence for analysis. Further, a person could analyze time stamps of certain activities and reconcile them with time stamps of identification, or they could manually analyze a video feed or images to evaluate which images were analyzed or not analyzed by software.

In performing a gender distribution analysis of a group of people walking through a given area of interest, for illustrative purposes only, a report of some sort could theoretically provide the output of all identified subjects listing the gender designation (male, female, or unknown), alongside time stamps, images, or any other features or identifiers that were “collected”. If supplemental technology were used, a designation of “not detected” (or similar designation) could be listed alongside time stamps, images, or any other features or identifiers that were “collected”. This could be performed by reconciling the time stamp of a subject's presence (through a sensor or other technology) to the time stamp of any image (from a camera or other technology) and either running that image through the analysis program automatically or designating the image as “not detected”.

The technological output or report (or other form of analysis) could further be provided in a manner that allows a user to manually review for accuracy and/or make correction(s) and/or add additional data entry and/or make additional use of the information. The technological output or report (or other form of analysis) could also be categorized, labeled, and/or ranked through a variety of means to make it easier for review and/or input and/or use the information. Additionally, business rules could be established around the reporting and/or analysis capabilities. The correct images, “corrected” images, new labels tagged to the images, or newly tagged data to each image could then be reincorporated into a database, potentially for, but not limited to, the purpose of “training the database” and/or making it easier to analyze other images.

Other technologies and/or business rules could be utilized to further analyze an image and/or control the output of the analysis and/or cause some event, report, alert, or other form of output. For example, a known female-only area could be programmed to not accept male outputs or trigger an alert or response for any males that enter the area. Further, an individual subject could be identified through a combination of video-based technologies and other technologies, such as social media activity, historical behavior, or known regions and/or locations of residence or travel. For example, a subject could be given a higher probability of identification if the area of interest is within or closer to the subject's known regions and/or locations of residence or travel. In theory, a person walking into a diner in a small town that looks like someone residing in that same town is more likely to be that person than someone from a large city on the other side of the planet. The purposes and use cases of reconciling database-related information to correlative data in other databases are virtually endless. Image analysis outputs could be combined with tools related to business, technology, security, entertainment, or otherwise to provide other forms of output. For example, image analysis could be combined with point-of-sale transactional data to help correlate purchases to demographics or to individuals.

Image analysis can also be trained to provide different forms of output for different criteria. For example, in counting vehicles at an intersection, technology could be trained to understand eastbound versus northbound traffic through virtual trip lines, size analysis, motion analysis, or other forms of technology. In yet another example, an image of a customer entering a location could be stored, initially anonymously—later, when the customer is identified (perhaps through a transaction, such as a credit card transaction), the identity gets assigned to the image, thereby “tagging” all other matching or similar images of the customer. Further, the customer could then be associated to their demographics, their purchases, their behavior, or any other data points that may be able to be attributed to the subject. In yet another example, a subject could be identified as a returning customer to a store through analyzing the MAC address of the mobile device, and then correlating this information to the demographics and/or identity to share the “customer loyalty” of given subjects. Image analysis is also made more accurate by correlating other information, and sometimes more reliable information, to the images. For example, if a subject inputs their birthday or their age is known, that known variable can override or be applied to the image in question.

Image analysis capabilities also create opportunities to use cameras and/or images and/or video-based technologies to automate otherwise manual and/or subjective processes. For example, car dealership customers may test drive a vehicle or multiple vehicles, but the dealership employees and automobile manufacturers have limited ways to document and/or memorialize what car was driven, when it was driven, where it was driven, who drove it, for how long, and what the driving experience for the customer may have been like. A camera, cameras, or similar device(s) could be positioned on the dashboard or other location within or outside the vehicle in a way that provides images of the driver's features and/or driving activities and/or regions/areas of the driving experience and/or other features worth collecting images or data for. The experience could be time stamped to show the start time, end time, and/or duration of the test drive, and/or could be correlated to information about the driving experience, and/or could be correlated to the vehicle type, location, driver identification, or any other feature about the subject driving the vehicle. Further, the mood or other aspects of the driver, vehicle, drive, or time stamp could be collected beginning with, throughout, and/or after the driving experience through image analysis or other methods. Further, the purchasing decision or other business-related actions could be reconciled to the test drive data. A recording could also be taken for review, audit, security, or subjective-related reviews and/or corrective measures. The image analysis could even be performed through the activation or deactivation of the car and/or engine and/or other power source. Additionally, a mobile set of sensors and/or cameras would allow for more robust data collection.

Accurately analyzing images provides significant benefits. As image analysis accuracy improves through automated and/or manual processes and methods, more data can be collected and utilized for a variety of useful purposes. The application of GPS, metadata, and user-generated information, when combined with image analysis methods, makes the process more accurate and more valuable.

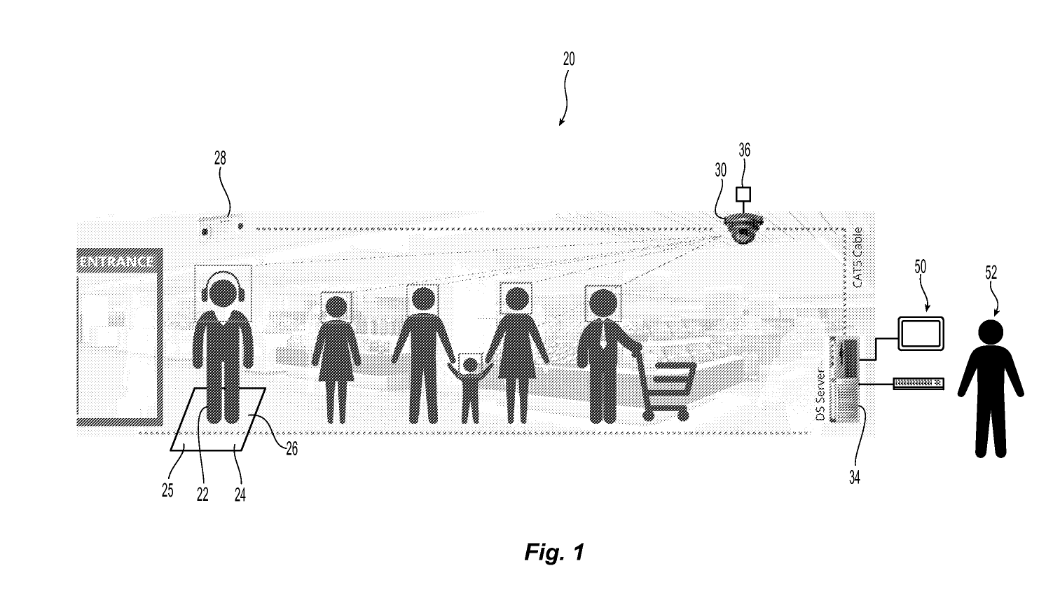

One embodiment of a system 20 for analyzing sensed data to acquire information about a target 22 is schematically depicted in FIG. 1. In this embodiment, the target 22 is a person entering a retail facility. A triggering mechanism 28 is positioned near the door and detects the target 22 as they enter through a doorway. More specifically, the illustrated triggering mechanism 28 is positioned to detect target 22 as they pass through a first spatial zone 24 just inside the door. Triggering mechanism 28 may be a motion detector or other suitable sensor for detecting target 22. Various other forms of triggering mechanisms are discussed below.

A sensor 30 is also used to detect targets 22 and acquire sensed data concerning the target 22. In a simple form, sensor 30 may simply act as a counter with the sensed data consisting of registering that at least one target passed through the monitored zone. More commonly, sensor 30 will acquire further information related to the target as discussed in more detail below. Sensor 30 defines a second spatial zone 26 in which it senses the presence of a target. In the example illustrated in FIG. 1, both triggering mechanism 28 and sensor 30 are focused on the same spatial zone 25. In other embodiments, however, triggering mechanism 28 and sensor 30 may be focused on spatial zones that are different.

Although the embodiment of FIG. 1 is configured to have individual humans as the target 22 of the system, other applications of the system might have alternative targets. For example, the system could be used in a manufacturing facility wherein the finished product, subassemblies or individual parts of the product are the target. In a food production setting, the target might be the initial ingredients, a partially completed food product or the finished food product. The system might also be employed in a packaging application to ensure that the correct number of items are contained in a package.

A wide variety of other applications and targets might also be employed with the system and method described herein. For example, instead of a living creature or object, the target 22 of the system might be a particular occurrence or event, such as the opening of a door, the activation of a particular piece of equipment, the accumulation of a predefined quantity of rainfall or any number of other events.

In the embodiment of FIG. 1, sensor 30 is an image sensor such as a camera or video camera which acquires an image of the target 22. While it may often be advantageous for sensor 30 to be an image sensor, other types of sensors might also be employed for other applications or to supplement the sensed data acquired by an image sensor. For example, sensor 30 in FIG. 1 might also include a microphone to sense and record audio information. In other applications, an automated scale might be used to monitor the weight of the target, a microphone without an image sensor might be used to record audio information, or any number of other sensors suitable for sensing something of interest could be used.

Returning to the embodiment illustrated in FIG. 1, a processor 34 receives signals from triggering mechanism 28 and sensor 30. Processor 34 is configured to analyze the received images and extract information therefrom which is saved in target data sets 38. Processor 34 also reconciles signals from triggering mechanism 28 and sensor 30 to improve the accuracy of the gathered information. The reconciliation of the signals from triggering mechanism 28 and sensor 30 is discussed in greater detail below.

It is further noted that while a system 20 could employ a single processor 34, it may often be advantageous to use several different processors to perform the various system tasks. For example, sensor 30 may have its own processor 36 which performs an analysis of the acquired image and communicates the results of the analysis to processor 34. Processor 34 may advantageously take the form of a network server and may be located either at the same location as triggering mechanism 28 and/or sensor 30 or may be located at a remote location. For example, processor 34 may be a remote server operated by a third party vendor implementing a “cloud” based service accessed over the internet.

Image analysis software is commercially available and known to those having ordinary skill in the art. Conventional image analysis software and techniques are used with the embodiment depicted in FIG. 1. The image analysis software may also be supplemented by having a human administrator review the acquired image. For example, and as further discussed below, a human administrator can review an image and its associated individual data target set and either modify, duplicate, delete or supplement the data set with additional information. This human review of the data set may also be employed with systems that acquire sensed data in addition to, or, instead of images.

Also depicted in FIG. 1 is a user interface station 50 allowing a human administrator to interact with system 20. In the illustrated example, user interface station 50 takes the form of a desktop computer and computer screen. Various other devices, e.g., a laptop computer, a mobile phone, a computing tablet or other suitable interface device, may also be used to allow administrator 52 to interact with system 20.

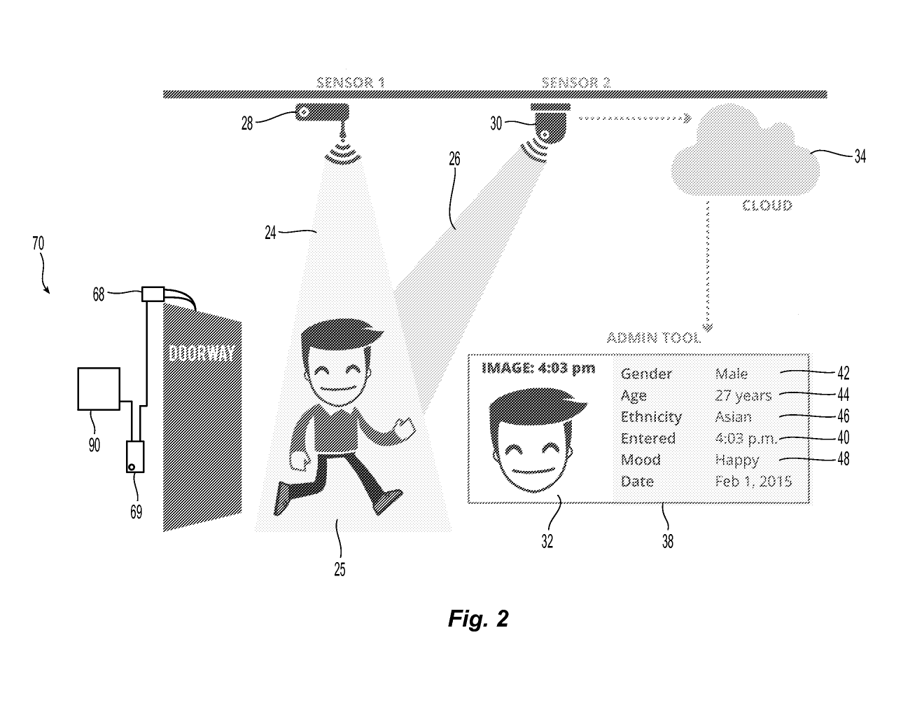

Another exemplary system 20 is depicted in FIG. 2. In this example, communication with processor 34 is over a public network, i.e., the internet and system 20 interacts with a building security system 70. Security system 70 includes a RFID (radio-frequency identification) card reader 69, door control device 68 and network server 90. In a typical security system 70, a larger number of doors or other access points will be in communication with server 90. In FIG. 2, only one such controlled access point is illustrated for purposes of graphical clarity. Device 68 may take the form of an automatic door opener or an automatic locking mechanism. Authorized personnel will generally be issued badges or cards having an RFID chip that can be read by RFID reader 69. The system 70 will either automatically open the door or unlock the door, allowing the user access if they have authority to enter the restricted area. Such security systems are well known to those having ordinary skill in the art.

FIG. 2 illustrates the user of a triggering mechanism 28 in the form of a motion detector and a sensor 30 in the form of a video camera. Both of these devices are in communication with server 34. In this example, however, by providing communication between security system 70 and server 34, card reader 69 could be used as the triggering mechanism and the motion detector labelled SENSOR 1 in FIG. 2 would not be necessary.

Also schematically depicted in FIG. 2 is a target data set 38 which has been generated in response to the detection and sensing of a target 22. In the example of FIG. 2, target data set 38 is a database entry having numerous fields. The image 32 acquired by sensor 30 is saved in one of the fields of the target data set 38. Although the illustrated embodiment includes only a single image for target data set 38, alternative embodiments could acquire multiple images or a short video sequence which are included in target data set 38.

The target data set 38 of FIG. 2 also includes a field for receiving a time stamp 40 corresponding to when the data was gathered. Several additional fields are shown for which values are generated by image analysis software. In this example, these fields include demographic information such as a gender value 42, an age value 44, an ethnicity value 46 and a mood value 48. Various other values might also be evaluated and recorded depending upon the particular application of system 20 and the type of target being monitored. For example, if the target is a human, additional values that might be included in the target data set 38 may include height, weight, clothing style, clothing color, logos visible on the clothing, hair color, attractiveness or other visual trait. Either image analysis software or review by a human administrator could be used to obtain these values.

Most commonly, target data set 38 will be a database entry as depicted in FIG. 2. Target data set 38, however, may take various other forms, such as an email, text message, simple electrical signal or other form of record, message or action which is reflective of the intelligence gathered by system 20. For example, it might be an electrical signal that initiates some other action such as the locking or unlocking of a door. The generation of an electrical signal could also be communicated to another device that simply counts the number of such signals received to thereby provide for an accurate count of targets.

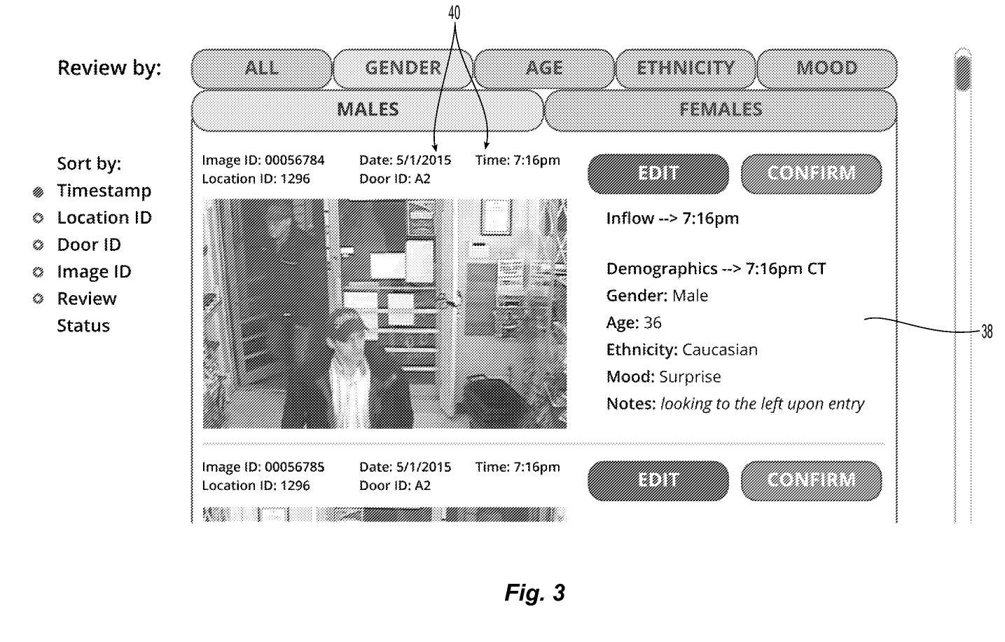

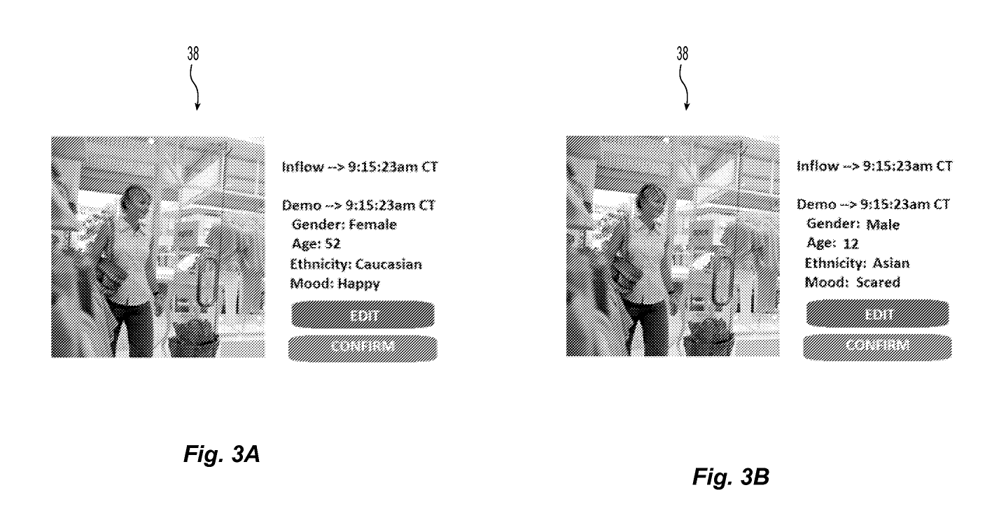

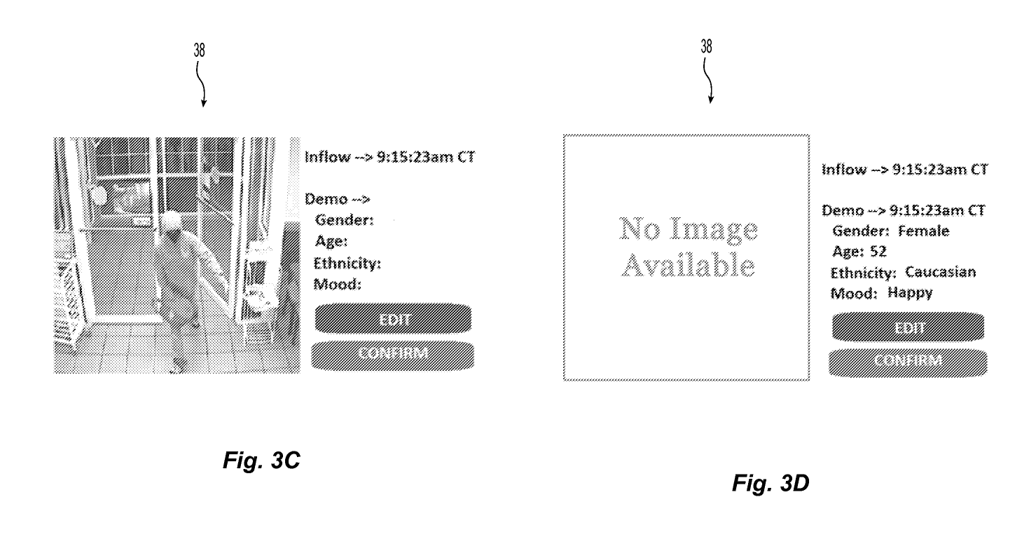

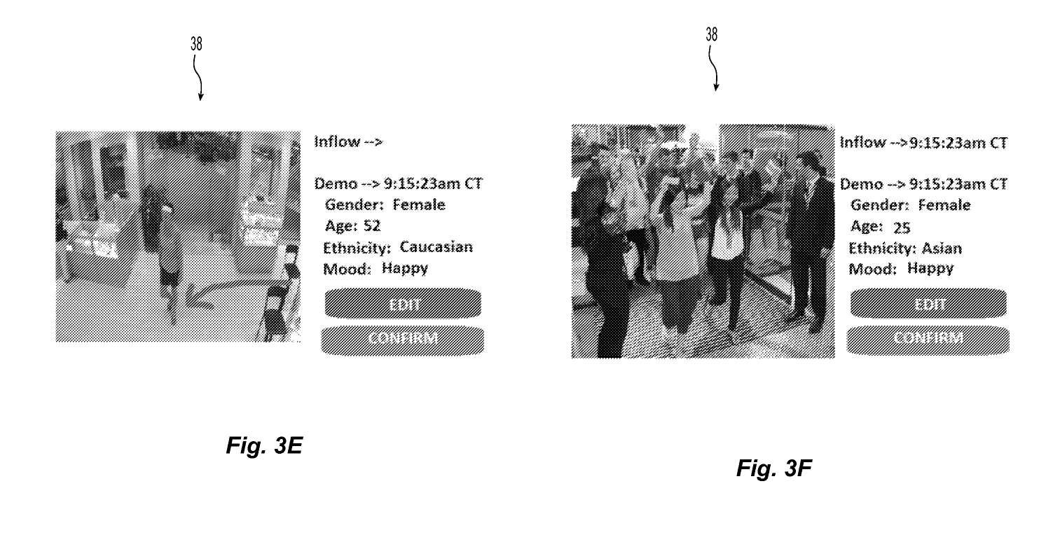

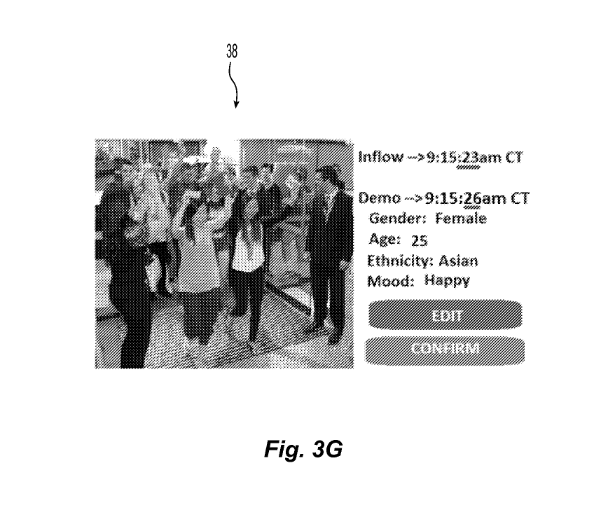

Various administrator tools can be used to review, modify, duplicate or delete the target data set and FIG. 3 depicts an example of a screen view of target data sets 38 that may be provided to an administrator 52 to allow for the review, modification, duplication, or deletion of target data sets 38. For example, if the data is all correct, the administrator can click on the confirm button and save the record as a valid target data set 38. If any of the values are incorrect, the administrator can click on the edit button. This will then allow the administrator to modify one or more the values. For example, the administrator might be able to double-click on one of the values and then edit and save that particular value. In some applications, it may be desirable to prevent the modification of some of the values. For example, it may be desirable to not allow for the modification of the time stamp. It may also be desirable for the administrator to have the ability to either duplicate or delete the entire record.

The illustrated example of FIG. 3 also provides for the filtering or searching of the target data sets. For example, the buttons at the top of the screen allow the administrator to search the target data sets by gender. FIG. 3 illustrates an example where the administrator has searched for records with a gender value of male. If the administrator clicks on the AGE search button, they will be able to search the records by age. For example, predefined age searches may allow the administrator to choose to return all records for targets having an estimated age of 0-20; 21-35; 36-45; 46-55 and 56+. Alternatively, it may provide for a free form search of the age field. Similarly, the example of FIG. 3 includes buttons for searching by ethnicity and mood. It also includes a search button that returns all records. The illustrated example also provides the administrator with the option of sorting the returned records by timestamp, location ID, Door ID, Image ID and review status.

FIGS. 3A-3G provide additional examples of target data sets and the reconciliation of signals from triggering mechanism 28 and sensor 30 for FIGS. 3A-3G is discussed below. It is noted that in FIGS. 3A-3G, the timestamp in the “Inflow” data field corresponds to triggering mechanism 28 while the timestamp in the “Demographics” data field corresponds to sensor 30.

FIG. 3A provides an example where a target is counted and additional data on the target is both collected and correct. This presents the situation where the initial acquisition of an image and analysis of the image worked correctly. In an automated system, after analyzing the image, the system will generate a target data set which, in this example, will have data fields which will all be completed and correct. If the system provides for input from a human administrator, the administrator would have the opportunity to review, edit and confirm the information. In this situation, the administrator would simply confirm the information.

FIG. 3B provides an example where a target is counted and additional data on the target is collected. Some of the additional information, however, is incorrect. This presents the situation where an image was acquired but the analysis of the image was incorrect. In an automated system, after analyzing the image, the system will generate a target data set which, in this example, will have all of the data fields completed but some of the fields will be incorrect. If the system provides for input from a human administrator, the administrator would have the opportunity to review, edit and confirm the information. In this situation, the administrator would be able to edit and correct the information.

FIG. 3C provides an example where a target is counted but the image analysis software was unable to determine any additional information about the target. As can be seen in this example, the apparel worn by the target individual obscures that individual's features. In an automated system, after analyzing the image, the system will generate a target data set which, in this example, will have the acquired image and a time stamp but the demographic data fields will be empty because the image analysis was unable to determine values for these fields. If the system provides for input from a human administrator, the administrator would have the opportunity to review, edit and confirm the information. In this situation, the administrator would be able to enter information into one or more of the empty data fields. If the administrator cannot determine values for certain data fields, those fields could be left empty or have an entry explicitly indicating that the value is unknown.

FIG. 3D provides an example where a target is counted and the image analysis software obtained additional information about the target but an image is not displayed. This might result from an issue with the network, the camera, the server, or some other source. In an automated system, after analyzing the image, the system will generate a target data set which, in this example, will not have an image but does include a time stamp and the additional demographic data. If the system provides for input from a human administrator, the administrator would have the opportunity to review, edit and confirm the information. In this situation, it might be possible for the administrator to review other images acquired at a time shortly before and after the time stamp. For example, if the image sensor acquired video images, additional images shortly before and after the time stamp may provide an image of the target. In such a system, it might also be possible for the administrator to select an image for inclusion in the target data set.

FIG. 3E provides an example where a target was not counted by the triggering mechanism but an image was acquired and additional information about the target was extracted from the image. This might result when a shopper who previously entered the store walks near the entrance while shopping. In an automated system, the system may flag the target data set as not corresponding to a signal generated by the triggering mechanism. The system might also be configured to prioritize the triggering mechanism whereby it simply deletes or does not create an individual data set in such a situation. If the system provides for input from a human administrator, the administrator would have the opportunity to review, edit and confirm the information. In this situation, the administrator could delete the record entirely if the administrator determined that it was acquired erroneously.

FIG. 3F provides an example where one target is counted and additional data on the target is collected. The image contains, however, several additional targets that were not counted. This can occur when multiple people pass by the sensor simultaneously. In an automated system, after analyzing the image, the system will generate a target data set which, in this example, will have all of the data fields completed and correct. The target data set, however, will only represent one of the targets depicted in the image and the other targets in the image are not counted. If the system provides for input from a human administrator, the administrator would have the opportunity to review, edit and confirm the information. In this situation, the administrator may be provided with the ability to duplicate and edit the target data set to thereby account for the additional people depicted in the image. This effectively allows the use of one timestamp for multiple records.

FIG. 3G provides an example where a target is counted and additional data on the target is collected but the time stamps from the triggering mechanism and image sensor do not agree. This can occur when multiple people pass by simultaneously and the triggering mechanism reacts to one target and the image sensor reacts to a different target. In an automated system, after analyzing the image, the system will generate a target data set which, in this example, will have all of the data fields completed and correct. When generating the target data set, the system may flag the disparity in the time stamps to allow for administrator review. It might also compare the time stamps and, if the difference between the timestamps is no greater than a predefined time period, simply accept the target data set as accurate and correct and, if it falls outside the predefined time period, delete or fail to create the target data set. If the system provides for input from a human administrator, the administrator would have the opportunity to review, edit and confirm the information to ensure that the records reflect the correct number of targets and contain correct information on the targets.

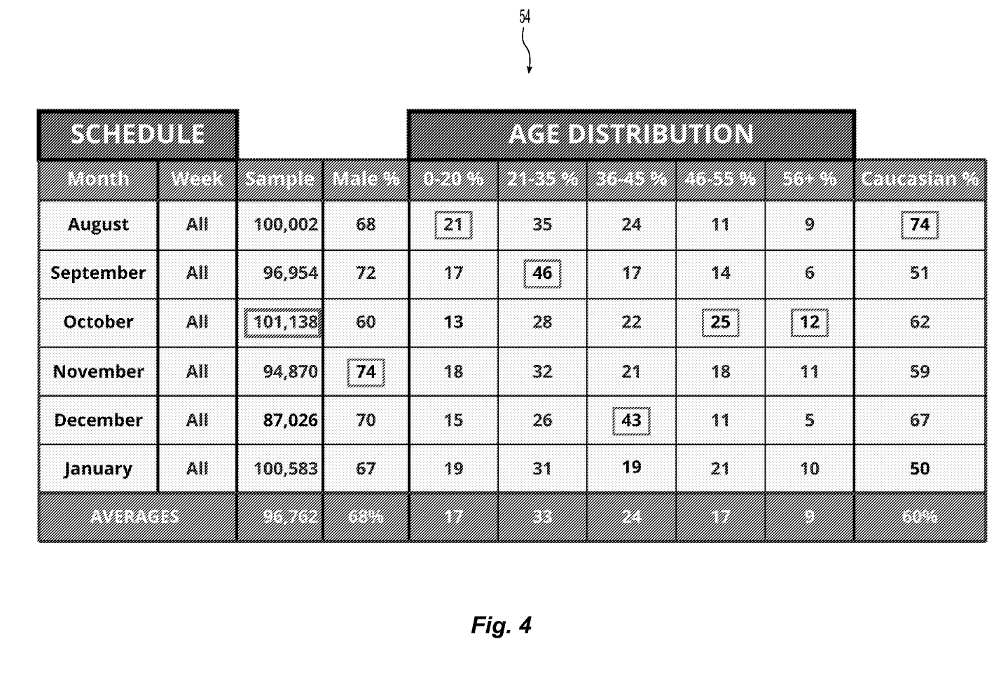

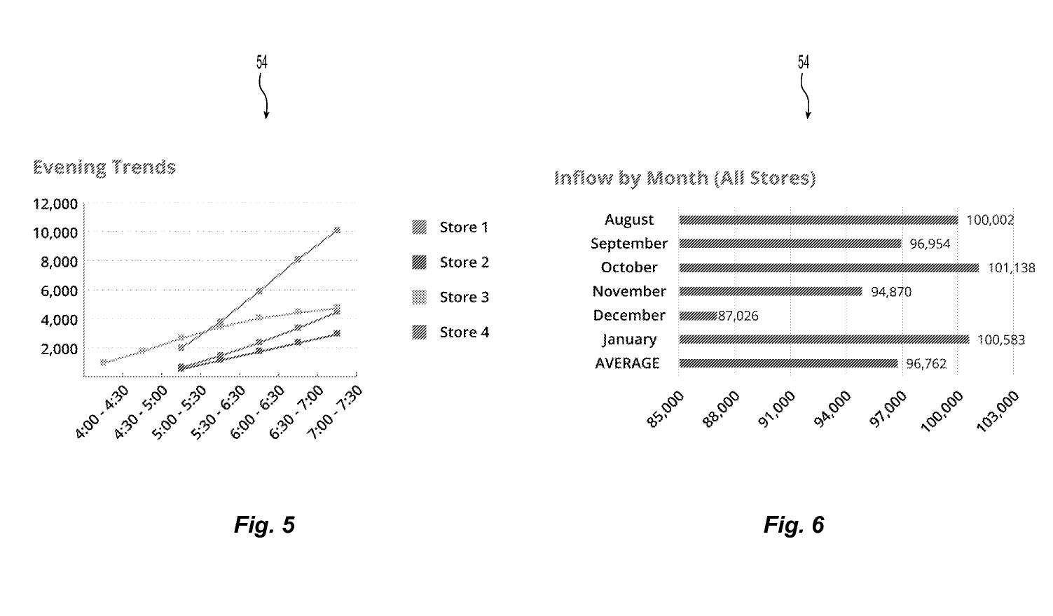

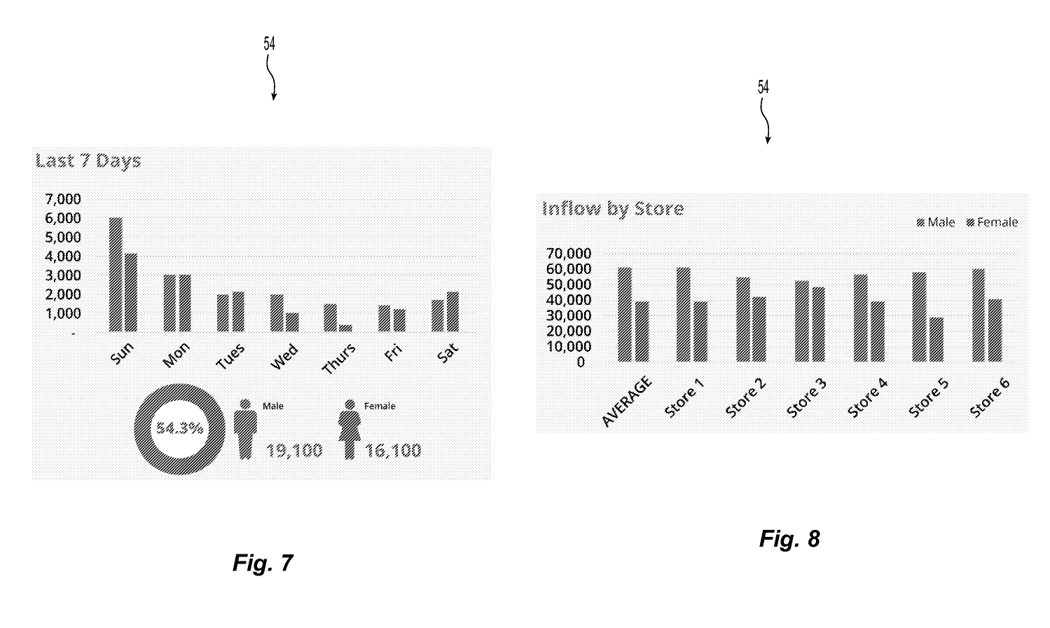

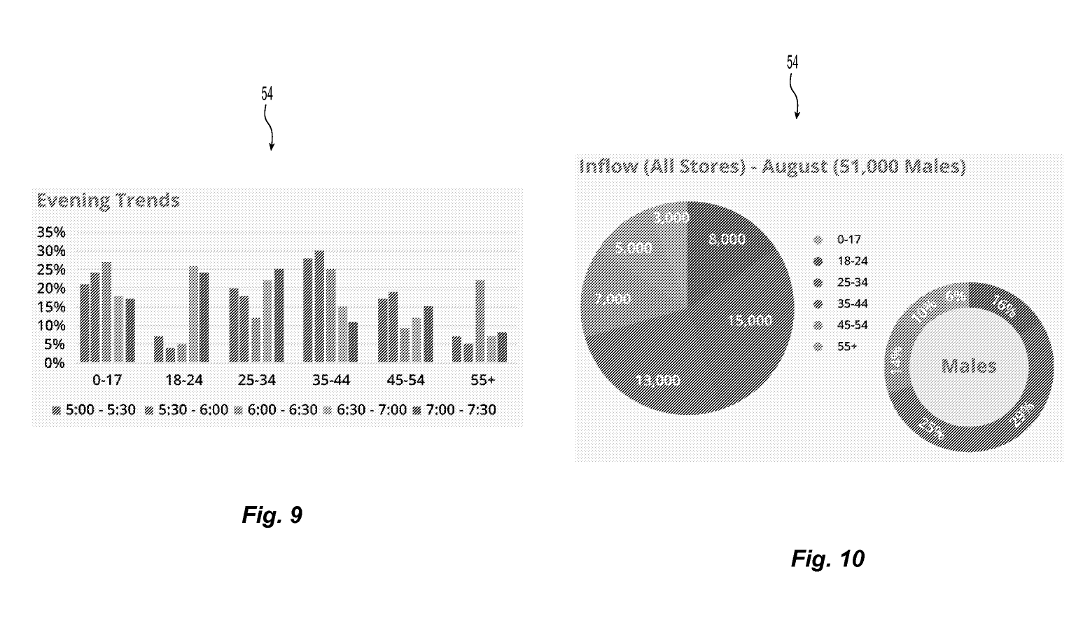

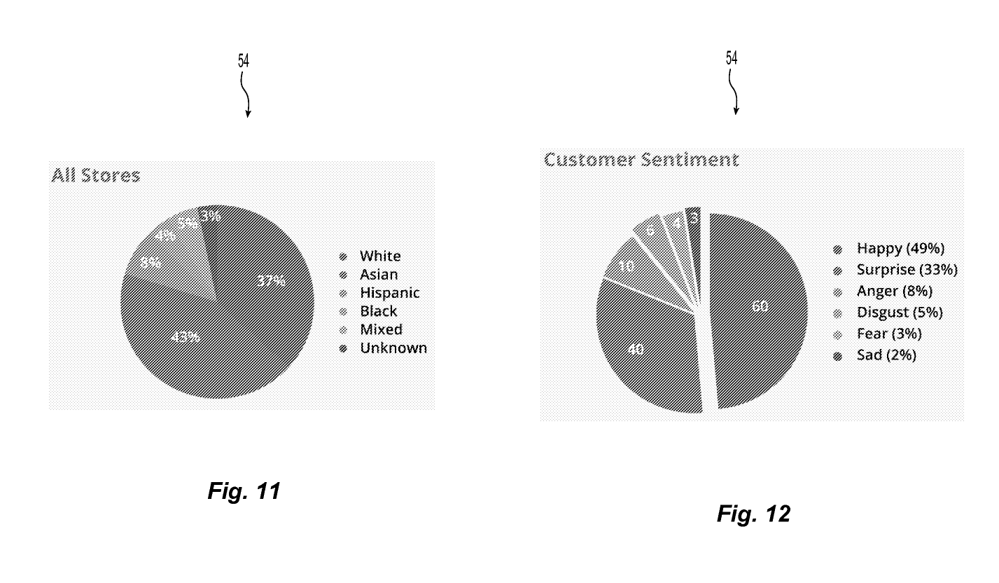

Once the validated target data sets 38 have been saved, the acquired data can be used to generate reports 54 as exemplified in FIGS. 4-12. It is well known to run and generate reports based upon database searches and such searching can be used to generate reports based on a database holding the target data sets 38 generated by system 20.

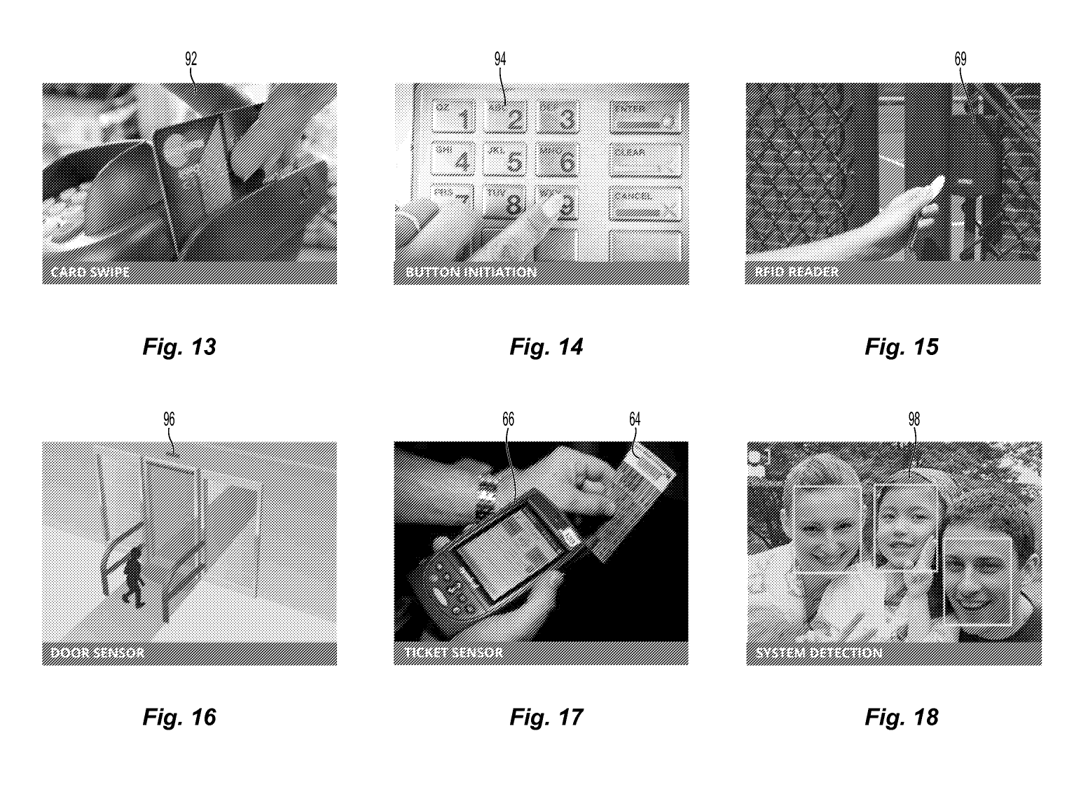

As mentioned above, various triggering mechanisms may be employed with the system. FIGS. 13-18 illustrate several examples of such triggering mechanisms. FIG. 13 illustrates a bank card reader 92 which can read credit and debit cards and is often used at point-of-sale locations. When using a bank card reader 92 as the triggering mechanism, the swiping of a bank card through the reader could be used as the triggering event. The spatial zone 24 of this type of triggering mechanism would generally be the space where the customer would typically stand when the customer, or a cashier, swipes the card. Generally, this would be in close proximity to the card reader 92, but in some applications it may be somewhat distant from the reader.

FIG. 14 illustrates a keypad 94 such as those often used on ATMs. For example, such a keypad could act as a triggering mechanism by communicating with the system 20 that the presence of a target has been detected when a customer begins entering a password on the keypad. Similarly, a touchscreen could also be used as a triggering mechanism.

FIG. 15 illustrates an RFID reader 69 to control access to an outdoor recreational enclosure such as fenced enclosure around a pool, tennis court or other similar area. An authorized user will generally be issued an RFID microchip embedded in a card, badge or other item. When the RFID microchip is brought in close proximity to the reader, the reader will be able to detect the chip and open the enclosure. When detecting the chip, the reader 69 may also communicate a signal to system 20 to thereby act as a triggering mechanism 28. RFID users suitable for use as a triggering mechanism are often used to control access to buildings, parking garages and other restricted access spaces.

FIG. 16 illustrates a door sensor 96 which might take the form of a motion detector or a floor mat sensor such as those used to automatically open doors at a grocery store.

FIG. 17 illustrates a code reader 66 used as a ticket reader to read a bar code or similar code feature on a ticket 64. This type of device is often used at sporting events, concerts and other public gatherings which require a ticket for admittance. In this particular embodiment, the ticket reader is portable and, thus, the spatial zone 24 associated with code reader 66 is not a permanent zone. Various other forms of code readers may also be employed as a triggering mechanism. For example, code readers in retail stores used to read UPC codes on products, or devices, such as mobile phones, which are used to read matrix bar codes such as a QR code may also be used as a triggering mechanism.

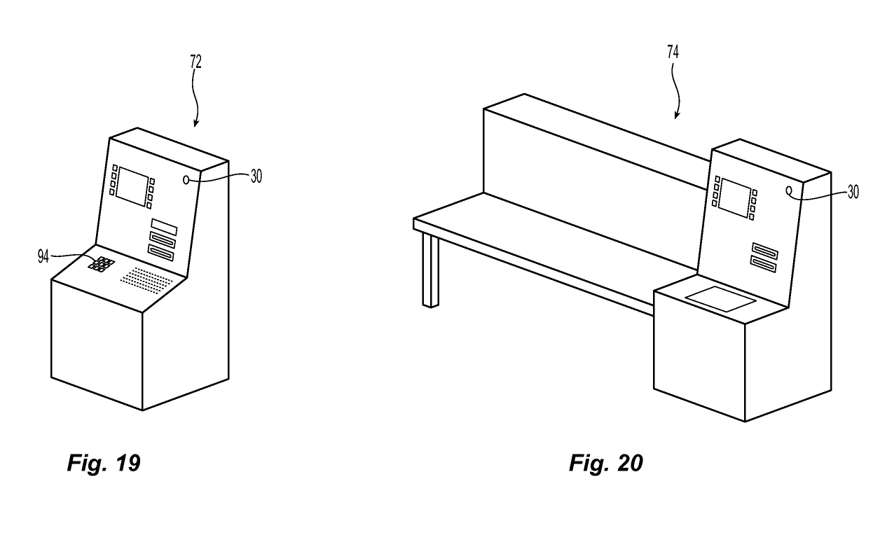

FIG. 18 illustrates the use of an image sensor 98 such as a camera or video camera with facial recognition capabilities which acts as a triggering mechanism 28. When using an image sensor as a triggering mechanism, the signal generated by the triggering mechanism and communicated to processor 34 advantageously includes a copy of the image. In such an application, where the sensor 30 is also an image sensor, each target data set generated by the system may advantageously include both images. For example, the two images may be acquired from different viewpoints whereby a better comprehensive view of the target is obtained.

FIGS. 19 and 20 illustrate the use of system 20 at a client service structure 72, 74. The illustrated client service structure in FIG. 19 is an ATM 72 while it is a point-of-sale device 74 in FIG. 20. Both of these devices may employ a sensor 30 that takes the form of an image sensor to record an image of the person using the device.

The use of a system 20 at an ATM 72 or point-of-sale device 74 can advantageously be used to detect potentially fraudulent activity. For example, when a person attempts a transaction using a bank card or similar item, the sliding of the card or other action by the person may be sensed by the triggering mechanism 28. The sensor 30 may take the form of a webcam, security camera or other image sensor and be focused on the user of the machine to record and/or transmit one or more images of the user to the processor 34. The processor 34 could then compare the demographic data of the rightful owner of the bank card with the demographics of the person attempting to use the bank card to identify potential fraud. For example, if the rightful card owner was a 56+ year old female and the person attempting to use the bank card was a 20-30 year old male, this would be identified as a potential fraudulent transaction. Depending upon the location and nature of the transaction, the processor 34 might be integrated with a local network having the demographic information on the rightful owner, alternatively, processor 34 could communicate with an external system to obtain such information for comparison with the demographic information generated for the target data set corresponding to the transaction.

If a potential fraudulent transaction was identified, processor 34 could communicate an alert, implement security features or other automated steps. For example, the user could be required to answer a security question before the transaction was completed, an alert could be sent to the rightful owner of the bank card, for example in a text message, a limit on the amount of the transaction could be automatically imposed or any number of other actions could be implemented.

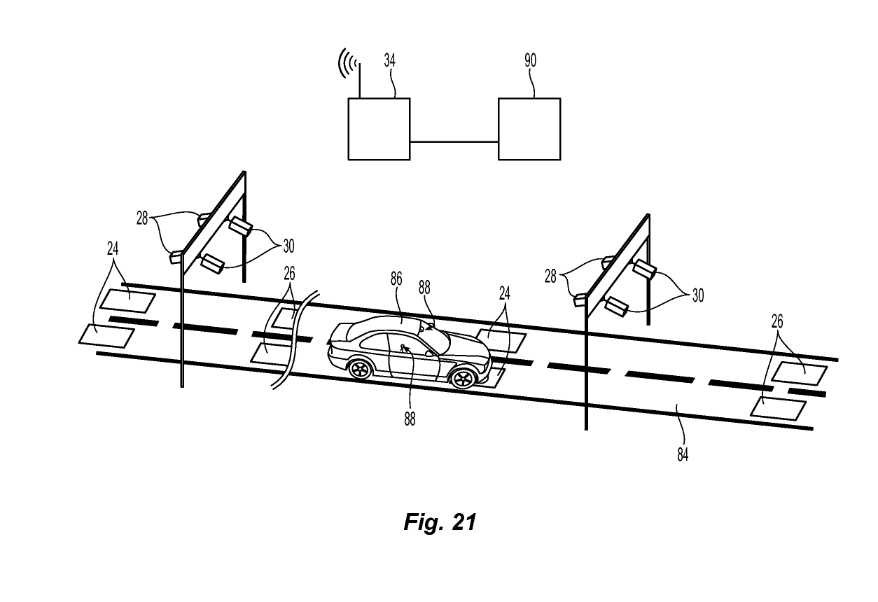

FIG. 21 illustrates the use of a system 20 along a roadway 84 wherein the target is a vehicle 86. In this example, there is a triggering mechanism 28 and paired sensor 30 for each lane of the roadway with several different locations on the roadway being monitored. For example, each lane of the roadway 84 could be monitored at 2 mile intervals along the roadway. In this particular application, it can be advantageous if both the triggering mechanism 28 and sensor 30 are image sensors which are positioned to face in opposite directions. If a single support structure is used to support both triggering mechanism 28 and sensor 30, this may result in the spatial zone 24 of triggering mechanism 28 and the spatial zone 26 of sensor 30 being at different locations on roadway 86 as depicted in FIG. 21. This arrangement, when both triggering mechanism 28 and sensor 30 are image sensors, can provide an image of the front of the vehicle to be captured by one of the two image sensors and an image of the rear of the car to be captured by the other image sensor. The images gathered by such a system can be analyzed for a number of different potential purposes. For example, images of vehicles in high occupancy lanes can be analyzed to determine the number of occupants 88 in the vehicle and thereby determine if the vehicle 86 has the required number of occupants 88 necessary to travel in the high occupancy lane. Various other data might also be included in the target data set such as the vehicle type, color, the speed of the vehicle, location, environmental conditions, or other relevant data.

In the illustrated example of FIG. 21, processor 34 communicates wirelessly with triggering mechanisms 28 and sensors 30. It is noted that the various components of all of the different embodiments disclosed herein may communicate via hard wired connections or wirelessly. Processor 34 is also in communication with an external system 90. For example, system 90 might be a dispatch station for a law enforcement agency.

The analysis of the images acquired by the roadway system depicted in FIG. 21 advantageously includes determining the license plate number and place of issuance of the vehicles in the images. The target data sets 38 acquired by the system may be subjected to a filter process with only those target data sets 38 meeting a particular criterion or criterions being the subject of communication to external system 90. For example, if a known vehicle is attempting to elude law enforcement, the filter process might search the records for a particular license plate and communicate any matches to external system 90. Advantageously, the communication of such information would be in real time. Such a search for a particular vehicle might be of short duration.

Other searches or filtering process might be done continually. For example, two separate monitoring locations identify a vehicle with the same license plate within a predefined time period an alert might be communicated to system 90 with that information. For example, if a vehicle traveled between two monitoring locations located several miles apart within such a short time that the vehicle was necessarily traveling at an extremely high speed that endangered the general public, this information could be communicated to an external system.

With reference to FIG. 21, it is also noted that, because the spatial zones 24, 26 monitored by triggering mechanism 28 and sensor 30 are different, the timestamps on the signals generated by triggering mechanism 28 and sensor 30 for an individual target would not be expected to be identical. In such an application, processor 34 advantageously computes the difference in the timestamps and considers the two signals to be in agreement if the computed difference is less than a predefined threshold.

It is also noted that when the triggering mechanism 28 and sensor 30 are arranged such that one of the two devices is likely to first detect the target, the triggering mechanism 28 and sensor 30 may be arranged such that either triggering mechanism 28 or sensor 30 will be the first to detect the target. It is also noted that for some applications, it will be the direction of travel of target 22 that will determine which of the triggering mechanism 28 and sensor 30 will be the first to detect target 22. For example if a system monitors a location where target movement occurs in opposing directions such as a pedestrian walkway where foot travel occurs in both directions, the triggering mechanism 28 might be expected to be the first to detect the target for one direction of travel with sensor 30 being expected to be the first to detect the target for the opposite direction of travel.

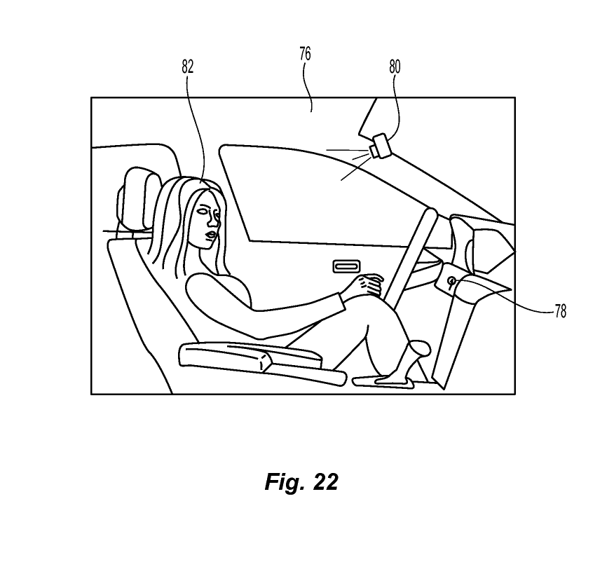

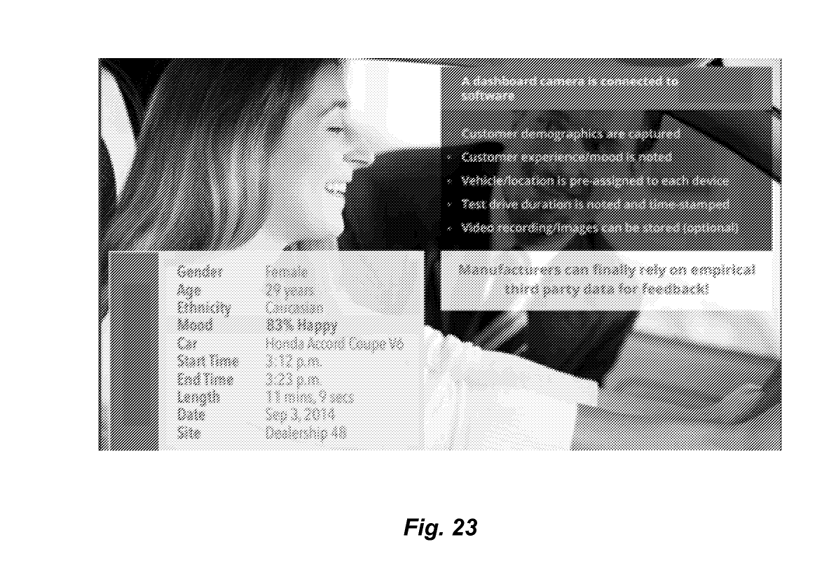

FIGS. 22 and 23 illustrate another potential application of the system disclosed herein. In this example, a system is installed in a vehicle 76 with the target being the occupant/driver 82 of the vehicle. This arrangement could be useful for monitoring sales efforts at a car dealership. In such a system, the ignition switch 78 could act as the triggering mechanism and a camera 80 could be mounted in the vehicle to record driver 82 and assess her experience driving vehicle 76.

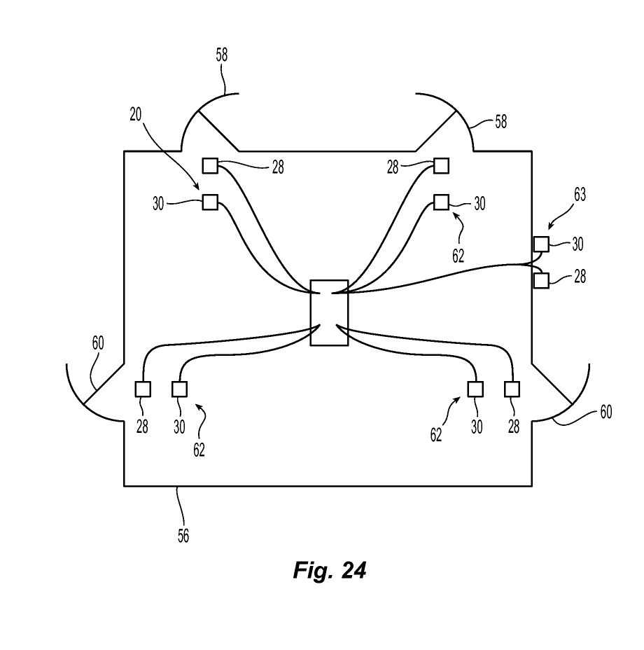

Another potential application of the system is schematically depicted in FIG. 24. In this example, the system is deployed at a predefined space 56 having a number of entry portals 58 and exit portals 60. Although these portals are described as separate entry and exit portals, they might alternatively be both an entry and an exit portal. In this example, in addition to the first paired set of triggering mechanism 28 and sensor 30, several additional paired sets of a triggering mechanism 28 and a sensor 30 are in communication with the system to cover multiple locations within the space 56. A paired set 63 of a triggering mechanism 28 and sensor 30 is also located on the outside 63 the space 56 in the example of FIG. 24. This type of arrangement could be used to monitor customer behavior in a retail facility or employee behavior at a work facility. In a retail environment, one of the paired sets 62 might be located at a deli counter, another at a bakery counter, etc. In a work environment, one paired set 62 might be located to monitor when employees enter the facility at the beginning of their shift. Others might be used to monitor employee activities at key locations. Paired set 63 could be positioned to monitor employees who use an outdoor smoking area to determine if the privilege of using such an area is being abused.

While the example of FIG. 24 relates to a building structure, such systems might be employed in outdoor locations such as parks or city streets.

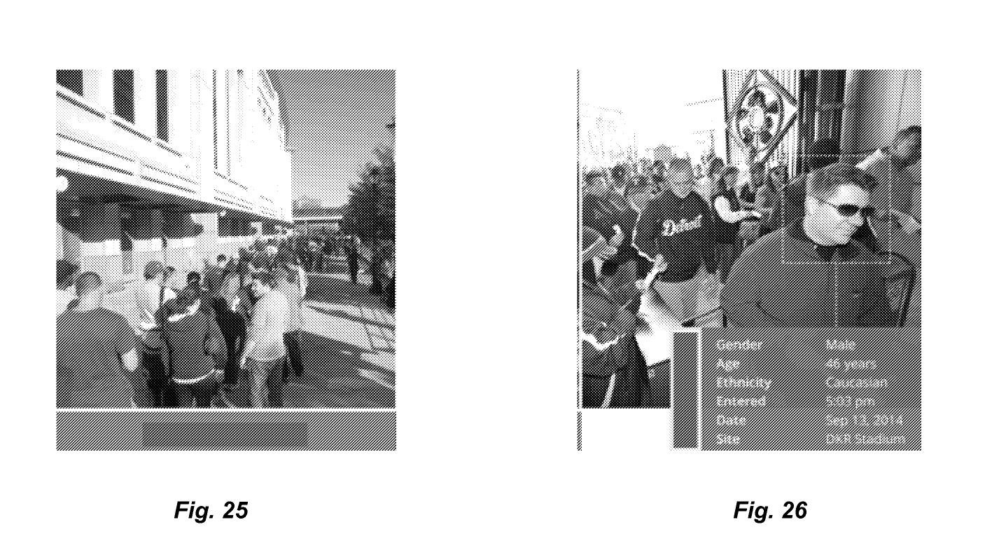

FIGS. 25 and 26 depict the use of such a system at a sports stadium. In this example, the system may monitor patrons entering and/or exiting the stadium. It may also monitor those waiting in line to enter the stadium. Multiple paired sets of trigging mechanisms 28 and sensors 30 could be used to monitor many different locations outside each gate. It would also be possible to integrate existing security cameras into the system. In such an integrated system, it would be possible to grab an image, or short duration video, from each of the security cameras whenever a nearby trigger mechanism 28 was activated. In such a system, there would be multiple sensors 30 linked with a single triggering mechanism 28.

In other applications, it would be possible for multiple triggering mechanisms 28 to be paired with a single sensor 30. In such an application, any one of the triggering mechanisms 28 might be sufficient to validate a target data set 38. Alternatively, it might require certain conditions to be met to validate a target data set. For example, if there were three triggering mechanisms, it might require that activation of two of the triggering mechanisms in a particular order within predefined time period without activating the third triggering mechanism which indicates that the target traveled along a particular path.

In yet another potential application, if the target is an object of manufacture, the sensed value might be used to determine if the object is defective. If one of the sensed values is determined to be unacceptable, e.g., the weight of a package supposed to hold a given weight of a product, the system might generate a signal that, in turn, activates equipment resulting in the segregation of the defective object. Many other applications for a system in accordance with the principles taught herein are also possible.

While this invention has been described as having an exemplary design, the present invention may be further modified within the spirit and scope of this disclosure. This application is therefore intended to cover any variations, uses, or adaptations of the invention using its general principles.

What is claimed is:

1. A system for analyzing sensed data to acquire information about at least one target in at least one predefined spatial zone, the system comprising:
a triggering mechanism configured to communicate to the system a first signal responsive to the presence of a target in a first predefined spatial zone;
a sensor configured to acquire sensed data of the target in a second predefined spatial zone and communicate to the system a second signal including the sensed data;
at least one processor in communication with the system configured to analyze the sensed data and determine if the sensed data detects the target; and
wherein the at least one processor is further configured to reconcile the first and second signals respectively generated by the triggering mechanism and the sensor wherein:
when a pair of first and second signals each respectively indicate the presence of the target in the first and second predefined spatial zones within a predefined time period, the at least one processor generates a target data set corresponding to the pair of first and second signals; and
when the detection of the target in one of the first and second predefined spatial zones is indicated by only one of the first and second signals, the at least one processor is configured to determine whether the detection of the target is more reliable than the absence of detection, and, if the detection of the target is determined to be more reliable, the at least one processor generates a target data set corresponding to the one signal indicating detection of the target.

2. The system of claim 1 wherein, when the detection of the target in one of the first and second predefined spatial zones is indicated by only one of the first and second signals, the at least one processor saves a target data set corresponding to the one signal only if the detection of the target is determined to be more reliable than the absence of detection.

3. The system of claim 1 wherein, when the detection of the target in one of the first and second predefined spatial zones is indicated by only one of the first and second signals, the at least one processor generates a target data set corresponding to the one signal indicating detection of the target and flags the target data set.

4. The system of claim 1 wherein the sensor is an image sensor that is configured to acquire an image of the target in the second predefined spatial zone and wherein the at least one processor is configured to analyze the image to detect the target in the image.

5. The system of claim 4 wherein, when a target data set is generated and the corresponding second signal includes an acquired image, the target data set includes the acquired image.

6. The system of claim 4 wherein the image sensor acquires an image responsive to the generation of the first signal by the triggering mechanism.

7. The system of claim 4 wherein the image sensor acquires images independently of the operation of the triggering mechanism.

8. The system of claim 1 wherein each of the first and second signals includes a time stamp and the at least one processor compares the time stamps of the first and second signals to determine if a pair of first and second signals are within a predefined time period.

9. The system of claim 1 wherein the first and second predefined spatial zones are the same spatial zone.

10. The system of claim 1 wherein the first and second predefined zones are different spatial zones.

11. The system of claim 1 wherein the communication or absence of the first signal is always determined to be more reliable than the communication or absence of the second signal.

12. The system of claim 1 wherein the at least one processor is configured to receive user input when determining whether the detection of the target is more reliable than the absence of detection.

13. The system of claim 1 wherein each of the target data sets includes a target count.

14. The system of claim 1 wherein the target is a human.

15. The system of claim 14 wherein each target data set includes a value for at least one of the target gender, the target age, the target ethnicity and the target mood.

16. The system of claim 1 wherein the triggering mechanism is a motion detector.

17. The system of claim 1 wherein the at least one processor is configured to receive user input allowing for the selective correction of data values in the target data sets and selective deletion of the target data sets.

18. The system of claim 1 wherein the system monitors entry of targets into a predefined space having limited entry and exit portals.

19. The system of claim 18 wherein entry into the space requires a ticket and the triggering mechanism is a ticket reader.

20. The system of claim 18 wherein the triggering mechanism is an automated entry device.

21. The system of claim 18 wherein the triggering mechanism is a security system.

22. The system of claim 18 wherein the system further monitors targets exiting the predefined space through an exit portal.

23. The system of claim 1 wherein the system monitors a client service structure.

24. The system of claim 23 wherein the client service structure is an automated teller machine.

25. The system of claim 23 wherein the client service structure is a self-service point-of-sale device.

26. The system of claim 1 wherein the triggering mechanism and the sensor are installed in a vehicle, the target is an occupant of the vehicle and the sensor is adapted to acquire an image of the target.

27. The system of claim 1 wherein the first and second predefined zones are portions of a roadway, the target is a vehicle and the sensor is adapted to acquire an image of the target.

28. The system of claim 27 wherein the target data sets include a value for the number of passengers in the vehicle.

29. The system of claim 1 wherein the at least one processor is configured to filter target data sets to identify a subset of one or more targets.

30. A method of analyzing images to acquire information about at least one target in at least one predefined spatial zone, the method comprising:
generating a signal responsive to the presence of a target in a first predefined spatial zone using a triggering mechanism;
acquiring an image of the target in a second predefined spatial zone with an imaging sensor and generating a second signal including the image;
analyzing the image to detect the target in the image; and
reconciling the first and second signals by:
generating a target data set when a pair of first and second signals respectively indicate the presence of the target in the first and second predefined spatial zones within a predefined time period; and
when the detection of the target in one of the first and second predefined spatial zones is indicated by only one of the first and second signals, determining whether the detection of the target is more reliable than the absence of detection, and, if the detection of the target is determined to be more reliable than the absence of detection, generating a target data set corresponding to the one signal indicating detection of the target.

31. The method of claim 30 wherein, when the detection of the target in one of the first and second predefined spatial zones is indicated by only one of the first and second signals, a target data set corresponding to the one signal indicating detection of the target is only saved if the detection of the target is determined to be more reliable than the absence of detection.

32. The method of claim 30 wherein, when the detection of the target in one of the first and second predefined spatial zones is indicated by only one of the first and second signals, a target data set corresponding to the one signal indicating detection of the target is generated and subjected to further review.

33. The method of claim 30 further comprising the step of collecting the target data sets and generating a report communicating information based on the target data sets.

34. The method of claim 33 further comprising the step of filtering the target data sets to identify target data sets satisfying one or more predefined conditions and wherein the generated report includes information obtained by the filtering step.

35. The method of claim 30 wherein the targets are humans entering a facility through an entrance.

36. The method of claim 35 wherein a plurality of paired triggering mechanisms and imaging sensors are used to monitor separate locations at the facility.

37. The method of claim 36 further comprising the step of matching specific targets in the target data sets acquired from the separate locations at the facility to thereby track movement of the specific targets at the facility.

38. The method of claim 37 wherein the targets are customers at a retail facility.

39. The method of claim 37 wherein the targets are employees.

40. The method of claim 30 further comprising communicating a message to an external system responsive to the generation of a target data set.

41. The method of claim 40 further comprising filtering the target data sets and communicating the message to the external system only when the target data set satisfies one or more predefined conditions.
